(19) United States
(12) Patent Application Publication
(10) Pub. No.: US 2002/0031590 A1
(43) Pub. Date: Mar. 14, 2002

(54) BAKERY PRODUCT

(76) Inventors: JEAN-JACQUES DESJARDINS, DENGES (FR); KATRIN HOLZ GAGG, PULLY (DE); PIERRE WUERSCH, LA TOUR-DE-PEILZ (CH)

Correspondence Address: WINSTON & STRAWN, 200 PARK AVENUE, NEW YORK, NY, 10166-4193, US

(21) Appl. No.: 09/395,067

(22) Filed: Sep. 13, 1999

(30) Foreign Application Priority Data
Sep. 28, 1998 (DE) 29817271.9

(51) Int. Cl. A23L 2/00

(52) U.S. Cl. 426/549; 426/590

(57) ABSTRACT

Sweet bakery products that can be consumed as is or which are also consumable as a beverage after stirring into hot milk. These products are produced by baking a dough-like shapable composition which is without cereal flour contents and contains starch and mono- or di-saccharides, as well as fat, plant proteins, flavoring, aromatizing and coloring ingredients, a raising agent.

### TECHNICAL FIELD

The present invention relates to a sweet bakery product that, after stirring into hot milk, is also consumable as a beverage.

### BACKGROUND ART

Sweet bakery products, which for the purposes of the present invention are taken to mean especially sweet small bakery products of the deposited cake-type biscuit or other biscuit types. Beverages can also be prepared from these products with the addition of a liquid, and preferably a hot liquid such as water or milk. Such products traditionally belong to different types of consumer food products.

In the infant food sector, for example, there are foods of the baked goods type which readily disintegrate in contact with milk and can be stirred to form pulpy beverages. These generally do not have the character of a beverage with little or no solids content.

European Patent Application EP 0 743 003 A1 discloses a bakery product that is soluble in tepid or hot aqueous liquids such as milk, which bakery product, based on the total weight of dry matter, comprises from 20 to 62% of a starch, in particular maize starch or wheat starch, and from 13 to 45% of mono- and di-saccharides in the form of sucrose and glucose syrup, as well as fat, soya proteins and cocoa or chocolate. From a mixture of these ingredients, a shapable dough is produced with addition of water, which dough is shaped in a conventional manner to form a small bakery product of the biscuit type which is then baked. The resultant bakery product can later be processed, if desired, to form a beverage by dissolution in milk having a temperature of 40° C. or above. If the relative amount of milk is decreased, the product can also be processed to form a pudding composition.

In order to meet the need for such products, the present invention provides new products of this type.

### SUMMARY OF THE INVENTION

The invention relates to a sweet bakery product that is also consumable as a beverage after stirring into a hot liquid, comprising a baked composition which is essentially free of cereal flour and includes above 10 to less than 20% by weight (dry matter) of starch and above 45 to 60 by weight (dry matter) of mono- or di-saccharides. The baked product may be consumed as is or as a beverage after being mixed into a hot liquid. Preferably, after dissolution in hot milk in an amount of from 5 to 15 parts by weight of bakery product per 100 parts by weight of milk, a homogeneous beverage having virtually no perceptible solids content is prepared.

In this product, the starch is preferably present in an amount of 12 to 19.5% by weight (dry matter). The starch can be a native maize starch or a wheat starch and is most preferably present in an amount of about 14 to 19%. The mono-or di-saccharides are preferably present in an amount of 50 to 53% by weight (dry matter). The mono- or di-saccharides can be provided by sucrose, fructose or glucose, either as powder or in the form of a syrup.

The sweet bakery product can also include a coating or a decoration made of a cocoa product thereon, with the coating being provided entirely or partially on the product. The cocoa product can be a white, dark or milk chocolate.

The invention also relates to a method of making a liquid beverage by forming baked pieces of the sweet bakery product described herein by baking the composition, and then adding one or more of the pieces to a hot liquid, with stirring, to form the liquid beverage. The liquid is preferably milk and is heated to a temperature of at least 25 to 40° C. before the pieces are added. Each piece preferably has a weight of between 2 and 5 grams, and a preferred total of about 5 to 15 grams of sweet bakery product are added per 100 grams of liquid to form the beverage.

### DETAILED DESCRIPTION OF THE PREFERRED EMBODIMENTS

According to the present invention, a sweet bakery product is created that is consumable as such or, after stirring into a hot liquid, is consumable as a homogeneous liquid beverage. This product can be produced by baking a dough-like shapable composition which preferably has no cereal flour content and includes the disclosed amounts of starch and of mono- and/or di-saccharides. If desired additional ingredients such as fat and/or plant proteins, flavoring, aromatizing or coloring ingredients, raising agents, and salt, and, if appropriate, water.

The term “essentially free” of cereal flour means that the bakery product contains less than 2%, and preferably less than 1% cereal flour. Generally, no cereal flour is present in these products.

The mono- or di-saccharides are preferably provided by sucrose, for example, in the form of granulated sugar, fructose, or glucose, or in the form of a syrup of these compounds. For example, a glucose syrup, owing to its liquid, syrupy consistency when mixed with small amounts of water, contributes to the formation of a viscous, shapable dough-like composition which contains the desired ingredients. This composition can then be easily processed to provide shaped dough pieces prior to baking.

The starch that is used is preferably a native maize starch or wheat starch, e.g., a native waxy maize starch. Of course, other starches may also be used.

Any of a wide variety of additional ingredients can be included in the dough-like composition before baking. For example, a fat, such as butter or margarine, can be added in an amount of from 5 to 20% by weight, and preferably 8 to 15% by weight. A protein, such as a plant protein, can be added in an amount of from 0.2 to 5% by weight and preferably 0.5 to 2% by weight. Soya flour can be used as the plant protein if desired. A raising agent, such as a carbonate or bicarbonate compound, i.e., baking soda, can be added in an amount of 0.3 to 2% by weight, and preferably 0.5 to 1.5% by weight. A humectant, such as salt, can be added in an amount of between about 0.01 and 1% by weight, and preferably between 0.05 and 0.5% by weight. A small amount of water, typically below 12% by weight and generally in the range of about 3 to 9% by weight, can be added, if desired, to solubilize the ingredients and to enhance the consistency of the dough-like composition before baking.

To form a more appealing beverage, any of a wide variety of flavoring, aromatizing or coloring agents can be added. Preferred agents include fruit, chocolate, coffee or cocoa products, and these can be added to suit the taste of the final beverage to be consumed. Various aromas or colors can be selected and added depending upon the final beverage product to be made.

The composition is prepared by homogeneously mixing the ingredients into a dough-like composition and then shaping it into the form of small bakery product pieces, typically of a size of about 3 to 5 grams or more in a spherical, square or rectangular shape. Baking of these pieces is conveniently accomplished in a conventional oven for a period of time of between about 5 to 25 minutes at between 100 and 200° C. The size and shape of the pieces can affect the baking time, but optimum times and temperatures can be routinely determined by one of ordinary skill in the art. A sweet bakery product is obtained which has a hardness that is comparable with conventional biscuit bakery product, and can also be consumed directly as a fine-tasting bakery product. Typical hardness values range from about 0.6 to 0.7 kN.

After stirring one or more of such products into a warm or hot liquid such as water or milk, a beverage is obtained that then can be consumed as a beverage. The temperature of the liquid is not critical and can range from 25 to 40 C or more. Generally, the higher the temperature, the faster the products will dissolve in the liquid. Milk is preferred for use as the liquid, either in the form of whole milk, skimmed milk, low-fat milk or a plant-origin milk such as soya milk.

A flavored beverage can be prepared by adding a flavoring agent. For example, a cocoa flavor can be prepared by simply adding cocoa powder to the dough-like composition prior to baking. The amounts of cocoa or other flavoring agent to be used are not critical and can be determined by one of ordinary skill in the art.

To produce a particularly attractive bakery product, a total or partial coating of a cocoa product can be applied. The cocoa product can be a white, milk or dark chocolate. Alternatively, the bakery product can be provided with a decoration, e.g., in the form of a point or design, made of a cocoa product. White chocolate is a preferred cocoa product because it is readily soluble in hot milk.

It is considered surprising that a composition which comprises less than 20% by weight of starch has essentially no cereal flour and more than 50% by weight of sugar in the form of mono- and di-saccharides can be baked to give a bakery product of the biscuit type that is fairly readily soluble in hot milk to provide a fine-tasting beverage.

### EXAMPLE

The sweet bakery product of the invention is described in more detail below with reference to an illustrative example for its production.

By mixing maize starch (native waxy maize starch), granulated sugar, cocoa powder, butter, glucose syrup, soya flour, ammonium bicarbonate, salt and fructose, a homogeneous mixture was produced which had the following composition (in % by weight):

| | |
|---|---|
| Maize starch | 15% |
| Granulated sugar | 35.2% |
| Cocoa powder | 13.224% |
| Butter | 11.57% |
| Glucose syrup | 8.04% |
| Fructose | 8.04% |
| Soya flour | 1.81% |
| Ammonium bicarbonate | 1.074% |
| Salt | 0.248% |
| Water | 5.786% |
| | 100% |

After mixing these ingredients, a smooth, shapable dough-like composition of relatively low viscosity is provided. In a conventional manner, pieces of this composition were baked in an oven for a period of about 15 minutes at about 150° C. to form bakery products.

A fine-tasting sweet bakery product of the cocoa deposited cake-type biscuit in the form of typical deposited cake-like biscuits or other biscuits was obtained which biscuits have an average hardness of 0.632±0.025 kN and which can be consumed like conventional biscuits.

By stirring approximately 18 g (5 pieces) of these biscuits into approximately 150 ml of hot milk, a fine-tasting cocoa beverage is obtained that contains virtually no perceptible solids.

By stirring more or fewer biscuits into the milk, the taste of the resulting milk beverage can be adapted to the consumer's personal taste.

What is claimed is:

1. A sweet bakery product that is also consumable as a beverage after stirring into a hot liquid, comprising a baked composition which is essentially free of cereal flour and includes above 10 to less than 20% by weight (dry matter) of starch and above 45 to 60 by weight (dry matter) of mono- or di-saccharides; wherein the baked product may be consumed as is or as a beverage after being mixed into a hot liquid.

2. The sweet bakery product according to claim 1 wherein the starch is present in an amount of 12 to 19.5% by weight (dry matter) and the mono-or di-saccharides are present in an amount of 50 to 53% by weight (dry matter).

3. The sweet bakery product according to claim 2, wherein the mono- or di-saccharides are provided by sucrose, fructose or glucose.

4. The sweet bakery product according to claim 3, wherein sucrose, fructose or glucose are provided in the form of a syrup.

5. The sweet bakery product according to claim 2, wherein the starch is a native maize starch or a wheat starch and is present in an amount of about 14 to 19%.

6. The sweet bakery product according to claim 1, which further includes one or more of a protein, a fat, a flavoring, aromatizing or coloring ingredient, a raising agent, salt or water.

7. The sweet bakery product according to of claims 6, wherein cocoa powder and salt are present as flavoring, aromatizing and coloring ingredients, butter or margarine is present as fat, and soya flour is present as protein, with the total content of these ingredients being in the range from 20 to 30% by weight.

8. The sweet bakery product according to claim 1, wherein after dissolution in hot milk in an amount of from 5 to 15 parts by weight of bakery product per 100 parts by weight of milk, a homogeneous beverage having virtually no perceptible solids content is prepared.

9. The sweet bakery product according to claims 1, which further comprises a coating or a decoration made of cocoa products thereon, with the coating being provided entirely or partially on the product.

10. The sweet bakery product according to claim 8, wherein the cocoa product is a white, dark or milk chocolate.

11. A sweet bakery product that is also consumable as a beverage after stirring into a hot liquid, comprising a baked composition which is essentially free of cereal flour and includes about 12 to 19.5% by weight (dry matter) of starch, 50 to 53% by weight (dry matter) of mono- or di-saccharides, and one or more of a protein, a fat, a flavoring, aromatizing or coloring ingredient, a raising agent, salt or water; wherein the baked product may be consumed as is or as a beverage after being mixed into a hot liquid; wherein after dissolution in hot milk in an amount of from 5 to 15 parts by weight of bakery product per 100 parts by weight of milk, a homogeneous beverage having virtually no perceptible solids content is prepared.

12. A method of making a liquid beverage which comprises:
forming baked pieces of the sweet bakery product of claim 1 by baking the composition; and
adding one or more of the pieces to a hot liquid, with stirring, to form a liquid beverage.

13. The method of claim 12, wherein the liquid is milk and is heated to a temperature of at least 25 to 40° C. before the pieces are added.

14. The method of claim 13, wherein each piece has a weight of between 2 and 5 grams and a total of about 5 to 15 grams of sweet bakery product are added per 100 grams of liquid.

15. The method of claim 14, which further comprises at least partially coating or decorating the pieces with a cocoa product before adding them to the liquid.

16. The method of claim 15, wherein the pieces are fully coated with a cocoa product before adding them to the liquid.

17. The method of claim 16, wherein the cocoa product is a white, dark or milk chocolate.
